(19) United States
(12) Patent Application Publication
(10) Pub. No.: US 2022/0216491 A1
(43) Pub. Date: Jul. 7, 2022

(54) FUEL CELL SYSTEM

(71) Applicant: HONDA MOTOR CO., LTD., Tokyo (JP)

(72) Inventor: Naoki Imai, Wako-shi (JP)

(21) Appl. No.: 17/541,321

(22) Filed: Dec. 3, 2021

(30) Foreign Application Priority Data
Jan. 7, 2021 (JP) 2021-001231

(51) Int. Cl. H01M 8/04746; H01M 8/2465; H01M 8/04858

(52) U.S. Cl. CPC H01M 8/04776; H01M 8/0488; H01M 8/2465

(57) ABSTRACT

A fuel cell system includes a fuel cell stack, a first air compressor that is configured to pump air to the fuel cell stack and that is powered by the fuel cell stack, a second air compressor that is configured to pump air to the fuel cell stack and a driving voltage of which is less than a driving voltage for the first air compressor, and an auxiliary power source configured to supply power to the second air compressor.

### CROSS-REFERENCE TO RELATED APPLICATION

Priority is claimed on Japanese Patent Application No. 2021-001231, filed Jan. 7, 2021, the content of which is incorporated herein by reference.

### BACKGROUND OF THE INVENTION

### Field of the Invention

The present invention relates to a fuel cell system.

### Description of Related Art

In the related art, for example, fuel cell systems including fuel cell stacks as disclosed in Japanese Unexamined Patent Application, First Publication No. 2018-116855, Japanese Unexamined Patent Application, First Publication No. 2006-269371 and Japanese Unexamined Patent Application, First Publication No. 2005-108751 are known. The fuel cell stacks generate power by causing a fuel gas to react with oxygen in the air. The air is pumped to the fuel cell stack by an air compressor.

### SUMMARY OF THE INVENTION

In a fuel cell system, the inventor of the present application has found the following problems. In order to increase a power generation capacity of a fuel cell stack, there is a need to increase a discharging capacity of an air compressor. In this case, driving power for the air compressor is increased. Accordingly, a power source for driving the air compressor is also required to have higher voltage. However, it is desirable for the power source to have a lower voltage.

An aspect of the present invention is directed to operating a fuel cell system without using a high voltage power source.

<1> A fuel cell system according to an aspect of the present invention includes a fuel cell stack; a first air compressor that is configured to pump air to the fuel cell stack and that is powered by the fuel cell stack; a second air compressor that is configured to pump air to the fuel cell stack and a driving voltage of which is less than a driving voltage for the first air compressor; and an auxiliary power source configured to supply power to the second air compressor.

When the fuel cell system starts, for example, a person or the control device drives the second air compressor and supplies air from the second air compressor to the fuel cell stack. Here, the driving voltage of the second air compressor is less than the driving voltage of the first air compressor. For this reason, a low voltage power source is sufficient as the auxiliary power source configured to supply power to the second air compressor.

After the fuel cell stack has started to generate power, for example, a person or the control device drives the first air compressor and stops the second air compressor. Then, for example, a person or the control device supplies air from first air compressor to the fuel cell stack. Accordingly, when the fuel cell stack starts to generate power and the fuel cell stack requires a larger amount of air, a larger amount of air can be pumped to the fuel cell stack from the first air compressor, the driving voltage of which is greater than the driving voltage of the second air compressor. Here, power is supplied from the fuel cell stack to the first air compressor. Accordingly, when power is supplied to the first air compressor, a high voltage power source is not necessary.

As described above, according to the fuel cell system of the present aspect, it is possible to drive the fuel cell system without using the high voltage power source.

<2> In the fuel cell system according to the above-mentioned <1>, a configuration further including a valve mechanism configured to regulate the air discharged from the first air compressor to flow into the second air compressor and to regulate the air discharged from the second air compressor to flow into the first air compressor, may be employed.

The valve mechanism regulates the air discharged from the first air compressor to flow into the second air compressor and the air discharged from the second air compressor to flow into the first air compressor. Accordingly, it is possible to prevent the air discharged from each of the air compressors from unexpectedly entering the other air compressor. As a result, the fuel cell system is stably driven.

<3> In the fuel cell system according to the above-mentioned <1> or <2>, a configuration further includes a control device configured to control the first air compressor and the second air compressor, wherein, upon starting the fuel cell system, the control device drives the second air compressor and supplies air from the second air compressor to the fuel cell stack, and after the fuel cell stack has started power generation, the control device drives the first air compressor, stops the second air compressor and supplies air from the first air compressor to the fuel cell stack, may be employed.

The control device controls the first air compressor and the second air compressor. Accordingly, it is possible to smoothly switch between the first air compressor and the second air compressor. As a result, the fuel cell system is stably driven.

According to the aspect of the present invention, it is possible to operate the fuel cell system without using a high voltage power source.

### BRIEF DESCRIPTION OF THE DRAWINGS

FIG. 1 is a schematic view of a fuel cell system according to an embodiment of the present invention.

### DETAILED DESCRIPTION OF THE INVENTION

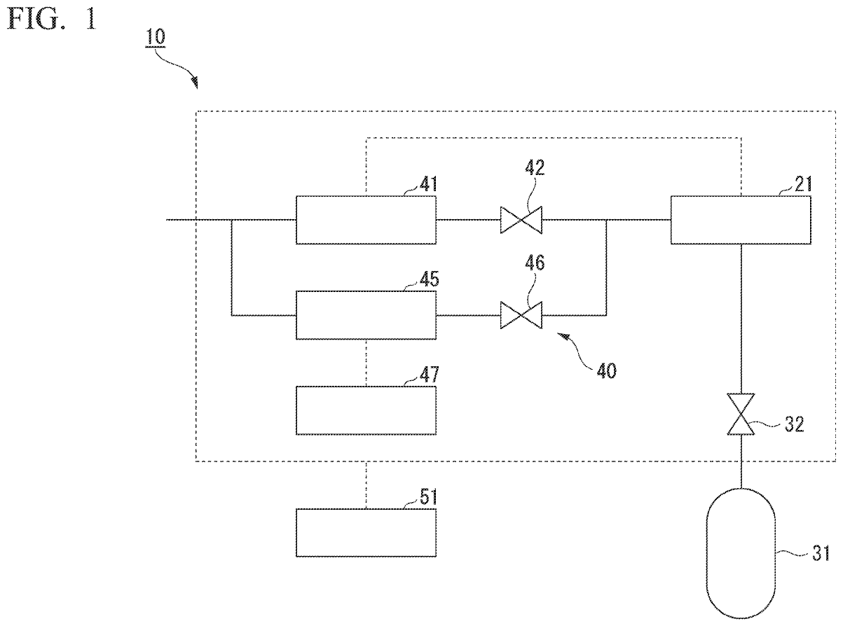

Hereinafter, a fuel cell system 10 according to an embodiment of the present invention will be described with reference to FIG. 1. The fuel cell system 10 of the embodiment is, for example, a stationary type. The stationary type fuel cell system 10 is not mounted on a moving body. However, the fuel cell system 10 is also applicable to a moving body such as a ship, a railroad having a diesel segment, or the like as appropriate. As a moving body to which the fuel cell system 10 is applied as appropriate, a moving body with no power source other than the fuel cell system 10 can be exemplified.

The fuel cell system 10 includes a fuel cell stack 21, a fuel tank 31, a first air compressor 41, a second air compressor 45, an auxiliary power source 47, a valve mechanism 40, and a control device 51.

The fuel cell stack 21 is, for example, a solid polymer type fuel cell. For example, the solid polymer type fuel cell includes a plurality of fuel cells which are stacked, and a pair of end plates configured to sandwich the stacked body of the plurality of fuel cells. The fuel cell includes an electrolyte electrode structure and a pair of separators configured to sandwich the electrolyte electrode structure. The electrolyte electrode structure includes a solid polymer electrolyte membrane, and a fuel electrode and an oxygen electrode that sandwich the solid polymer electrolyte membrane. The solid polymer electrolyte membrane includes a cation exchange membrane or the like. The fuel electrode (anode) includes an anode catalyst, a gas diffusion layer, and the like. The oxygen electrode (cathode) includes a cathode catalyst, a gas diffusion layer, and the like.

The fuel cell stack 21 generates power by a catalyst reaction between a fuel gas supplied from the fuel tank 31 to the anode and an oxidant gas such as air or the like containing oxygen supplied from the air compressors 41 and 45 to the cathode.

The fuel tank 31 stores fuel such as hydrogen or the like. The fuel tank 31 is connected to the anode of the fuel cell stack 21 via an opening/closing valve 32. The fuel tank 31 supplies the fuel to the fuel cell stack 21. The opening/closing valve 32 switches supply of the fuel on and off, and switches a pressure thereof and the like with respect to the fuel cell stack 21.

Each of the first air compressor 41 and the second air compressor 45 supplies air as an oxidant gas to the cathode of the fuel cell stack 21 upon power generation of the fuel cell system 10. Each of the first air compressor 41 and the second air compressor 45 is connected to the cathode of the fuel cell stack 21. Each of the first air compressor 41 and the second air compressor 45 pumps the air to the fuel cell stack 21.

Hereinafter, regarding a flow of the air supplied from each of the first air compressor 41 and the second air compressor 45 to the fuel cell stack 21, a direction from each of the first air compressor 41 and the second air compressor 45 toward the fuel cell stack 21 is referred to as a downstream direction, and an opposite direction thereto is referred to as an upstream direction.

A driving voltage of the second air compressor 45 is less than a driving voltage of the first air compressor 41. The driving voltage of the first air compressor 41 is, for example, 100 to 400 V. The driving voltage of the second air compressor 45 is, for example, 12 to 48 V, preferably 48 V.

The first air compressor 41 is powered by the fuel cell stack 21. The first air compressor 41 and the fuel cell stack 21 are connected so that power can be supplied.

The second air compressor 45 is powered by the auxiliary power source 47. The second air compressor 45 and the auxiliary power source 47 are connected so that power can be supplied.

The auxiliary power source 47 is a power source independent from the fuel cell stack 21. As the auxiliary power source 47, for example, a lead storage battery (a lead battery) or the like is exemplified. The auxiliary power source 47 is a starting power source used upon starting of the fuel cell system 10.

The valve mechanism 40 regulates the air discharged from the first air compressor 41 from flowing into the second air compressor 45. The valve mechanism 40 also regulates the air discharged from the second air compressor 45 from flowing into the first air compressor 41. In the embodiment, the valve mechanism 40 includes a first opening/closing valve 42 and a second opening/closing valve 46.

The first opening/closing valve 42 is disposed downstream of the first air compressor 41. The second opening/closing valve 46 is disposed downstream of the second air compressor 45. The first opening/closing valve 42 and the second opening/closing valve 46 are both disposed upstream of a merging point of the air discharged by the first air compressor 41 and the air discharged by the second air compressor 45. Further, the valve mechanism 40 may not include the first opening/closing valve 42 and the second opening/closing valve 46. For example, the valve mechanism 40 may be a three-way valve disposed at the merging point.

The control device 51 integrally controls operations of the fuel cell system 10.

The control device 51 is a software function part that is functioned by executing a predetermined program using a processor such as a central processing unit (CPU) or the like. The software function part is an electronic control unit (ECU) including a processor such as a CPU or the like, a read only memory (ROM) configured to store a program, a random access memory (RAM) configured to temporarily store data, and an electronic circuit such as a timer or the like. At least a part of the control device 51 may be an integrated circuit such as large scale integration (LSI) or the like.

The control device 51 controls each configuration. In the embodiment, the control device 51 is connected to each of the fuel cell stack 21, the opening/closing valve 32, the first air compressor 41, the second air compressor 45, the auxiliary power source 47, and the valve mechanism 40. The control device 51 controls each of the fuel cell stack 21, the opening/closing valve 32, the first air compressor 41, the second air compressor 45, the auxiliary power source 47, and the valve mechanism 40.

Next, an example of a starting method (an operating method) of the fuel cell system 10 will be described.

Upon starting of the fuel cell system 10, the control device 51 drives the second air compressor 45 to supply the air from the second air compressor 45 to the fuel cell stack 21. Here, a driving voltage of the second air compressor 45 is less than a driving voltage of the first air compressor 41. For this reason, a low voltage power source is sufficient as the auxiliary power source 47 configured to supply power to the second air compressor 45.

Further, here, the control device 51 opens the second opening/closing valve 46 and closes the first opening/closing valve 42. Accordingly, the air discharged from the second air compressor 45 does not flow into the first air compressor 41.

After the fuel cell stack 21 has started to generate power, the control device 51 drives the first air compressor 41 and stops the second air compressor 45. Then, the control device 51 supplies the air from the first air compressor 41 to the fuel cell stack 21. Accordingly, after the fuel cell stack 21 has started to generate power and the fuel cell stack 21 requires a larger amount of air, the large amount of air can be pumped to the fuel cell stack 21 from the first air compressor 41, a driving voltage of which is greater than the driving voltage of the second air compressor 45. Here, power is supplied from the fuel cell stack 21 to the first air compressor 41. Accordingly, even when power is supplied to the first air compressor 41, a high voltage power source is not necessary.

Further, here, the control device 51 opens the first opening/closing valve 42 and closes the second opening/closing valve 46. Accordingly, the air discharged from the first air compressor 41 does not flow into the second air compressor 45.

Further, a timing at which the second air compressor 45 is switched to the first air compressor 41 may be, for example, a timing at which the fuel cell stack 21 has started to generate power of a predetermined voltage or more. The predetermined voltage is, for example, equal to or greater than the driving voltage for the first air compressor 41. The predetermined voltage is previously stored in, for example, the control device 51.

In addition, other than the above-mentioned timing, the timing at which the second air compressor 45 is switched to the first air compressor 41 may be, for example, a timing at which a predetermined time has elapsed after the second air compressor 45 has started driving.

As described above, according to the fuel cell system 10 of the embodiment, it is possible to operate the fuel cell system 10 without using a high voltage power source.

The valve mechanism 40 regulates the air discharged from the first air compressor 41 to flow into the second air compressor 45 and the air discharged from the second air compressor 45 to flow into the first air compressor 41. Accordingly, the air discharged from each of the air compressors 41 and 45 is prevented from unexpectedly flowing into the other of the air compressors 41 and 45. As a result, the fuel cell system 10 is stably operated.

The control device 51 controls the first air compressor 41 and the second air compressor 45. Accordingly, it is possible to smoothly switch between the first air compressor 41 and the second air compressor 45. As a result, the fuel cell system 10 is stably driven.

Further, while the control device 51 switches between the first air compressor 41 and the second air compressor 45 in the above-mentioned embodiment, a person may switch them instead of the control device 51. In this case, for example, a person may input a control signal to control various configurations via an operation panel provided in the fuel cell system 10.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A fuel cell system comprising:
a fuel cell stack;
a first air compressor that is configured to pump air to the fuel cell stack and that is powered by the fuel cell stack;
a second air compressor that is configured to pump air to the fuel cell stack and a driving voltage of which is less than a driving voltage for the first air compressor; and
an auxiliary power source configured to supply power to the second air compressor.

2. The fuel cell system according to claim 1, further comprising a valve mechanism configured to regulate the air discharged from the first air compressor to flow into the second air compressor and to regulate the air discharged from the second air compressor to flow into the first air compressor.

3. The fuel cell system according to claim 1, further comprising a control device configured to control the first air compressor and the second air compressor,
wherein, upon starting the fuel cell system, the control device drives the second air compressor and supplies air from the second air compressor to the fuel cell stack, and
after the fuel cell stack has started power generation, the control device drives the first air compressor, stops the second air compressor and supplies air from the first air compressor to the fuel cell stack.
